(19) United States
(12) Patent Application Publication
(10) Pub. No.: US 2011/0297700 A1
(43) Pub. Date: Dec. 8, 2011

(54) UNIT FOR DISPENSING FLUIDS OR MIXTURES AND RELEVANT DISPENSING DEVICE

(76) Inventor: Evans Santagiuliana, Caldogno (VI) (IT)

(21) Appl. No.: 13/201,646

(22) PCT Filed: Feb. 26, 2010
(86) PCT No.: PCT/IB10/00415

§ 371 Date: Aug. 16, 2011

(30) Foreign Application Priority Data
Mar. 2, 2009 (IT) VI2009A000042

(51) Int. Cl. B05B 11/00; B05B 7/04; B05C 17/01

(52) U.S. Cl. 222/153.13; 222/336; 222/384; 222/190

(57) ABSTRACT

The present invention is a unit (1, Ia) for dispensing fluids (L) suited to be applied to a container, and comprises: a hollow body (2) defining a suction/compression chamber (3) for a fluid (L), provided with a suction duct (4) for the fluid (L), to which a piston (5) is slidingly coupled, wherein said piston (5) can be moved from a first lower position to a second upper position; valve means (19) suited to regulate the flow of the fluid (L) from the suction duct (4) into the suction/compression chamber (3) and to regulate its outflow towards a communication duct (Ha) in hydraulic communication with an outlet duct (1 ib) of the device; locking means (16) that can be activated by the user to lock the piston (5) in one of the lower and upper positions. Said valve means (19) comprise two elements (20, 21) slidingly coupled with each other so that when the piston (5) is locked in the first lower position the first element (20) creates a first tight area (20a) suited to prevent the passage of the fluid (L) from the suction duct (4).

The present invention concerns the packaging and dispensing of fluid products. In particular, the present invention concerns the sector of the devices for dispensing fluids or mixtures in atomized, liquid or foam form.

In greater detail, the present invention concerns a unit for dispensing a fluid, to be applied to a container containing said fluid, particularly suited to dispense food substances, perfumes or detergents in general, and a relevant dispensing device.

As already known, dispensing devices that are applied to the container of the product in question are widely used to dispense liquid or creamy products, like food substances, soaps, creams, detergents or perfumes.

Said devices are substantially constituted by a supporting element or cap provided with means for connection to the neck of the container and by a unit for dispensing the liquid contained in the container.

The dispensing units of known type comprise:
a hollow body defining a suction/compression chamber for the liquid, provided with a liquid suction duct with which a plunger is slidingly coupled, said plunger being suited to be moved from a first lower position to a second upper position;
valve elements suited to regulate the flow of the liquid coming from said suction duct into the chamber and to regulate its outflow from the chamber towards the unit's outlet duct.

More particularly, the plunger is provided with first connection means suited to be coupled with second connection means belonging to a rod having a duct communicating with the liquid outlet and provided with an actuator element that can be operated by the user.

The unit also comprises a metallic helical spring that allows the automatic return of the plunger to the upper or rest position, once the fluid has been dispensed.

Some known units also comprise locking means that can be activated by the user in order to lock the plunger and therefore the actuator element in one of the above mentioned first and second position.

Said means advantageously make it possible to avoid the accidental operation of the dispensing unit and, when the unit is locked with the piston in the lower position, to reduce the overall dimensions of the unit itself.

Said locking means are also used during the transport of the container. In fact, in such conditions it is preferable to lock the device in the minimum dimension configuration, that is, with the plunger and the actuator element in the lower position.

A first drawback posed by said units for dispensing fluids and by the corresponding devices is represented by the fact that during transport they assume casual positions that cause the undesired outflow of the liquid contained in the device. The drawback described above is particularly felt also in reference to the increasingly higher quality and operating standards required for dispensing units and the relevant devices.

The same inconvenience occurs after the first dispensing operation. More precisely, after said first dispensing operation, if the device and the unit are placed, for example, in overturned position, the undesired outflow of the liquid contained in the device takes place.

A further drawback lies in that after one dispensing operation, when the unit is in the rest position, the liquid present in the dispensing duct at the level of its terminal part (outlet) undesirably tends to flow out of the duct itself. Said leakages also cause the inconvenience of dirtying the container to which the dispensing unit is applied and/or the unit itself, and also represent a waste of product.

In view of the situation described above, a fluid dispensing unit and a device capable of overcoming or at least limiting the drawbacks posed by the known art would be desirable. It would thus be desirable to provide a fluid dispensing unit and a device that make it possible to overcome the drawbacks posed by the units and devices described above.

In particular, it is a first object of the invention to produce a unit for dispensing fluids or mixtures and a relevant device that have the same characteristics as the units and devices of the known type, but are more reliable than said units and devices.

It is a further object of the invention to provide a dispensing unit and a device that can be locked in the lower and upper position, so as to prevent them from being operated accidentally.

It is another object of the invention to provide a unit and a device that can be transported with no risk of leakage of the product contained in the container to which they are applied.

It is another object of the invention to provide a dispensing unit and a device that are free from any undesired leakage of the product contained in the container to which they are applied, independently of their position, even after the first dispensing operation. More particularly, it is another object of the invention to provide a unit and a device that don't allow the product contained in the container to flow out when they are locked in the above mentioned lower and upper position and overturned.

It is a further object of the invention to provide a unit and a device with no leakages from the dispensing duct.

It is another object of the invention to provide a unit that can be used in devices suited to dispense the liquid in the form of foam.

It is a further object of the invention to provide a unit that is simpler to construct.

It is another object of the invention to provide a dispensing unit that is reliable and has fewer tight areas than comparable units and devices of known type.

It is another object of the invention to provide a unit and a device having fewer parts that must be produced with the precision and care necessary for obtaining the tight areas.

It is another object of the invention to provide a unit and a device that considerably reduce production costs.

A further object of the invention is to propose a unit that can be used to produce any device for dispensing fluids or mixtures, even in the form of foam, like for example the dispensing devices called foamers.

It is a further object of the invention to propose a unit to be used to produce devices for dispensing liquids, advantageously, but not exclusively, detergent or food liquids.

It is a further object of the invention to carry out a dispensing device that can be locked/released by the user.

It is another object of the invention to carry out a device that also allows the user to select in advance the specific quantity of fluid to be dispensed in a non-sensitive way.

It is a further object of the invention to carry out a device for dispensing fluids where the quantity to be dispensed is predetermined upon its assembly or upon application to the container or before use.

It is another, yet not the least object of the invention to carry out a unit and a relevant device that are reliable, economic and easy to use, as well as easy to construct and to assemble, and suited to be produced in series.

The objects mentioned above are achieved by a unit for dispensing fluids and a device for dispensing fluids in accordance with the contents of the corresponding independent claims.

Advantageous embodiments of the invention are described in the dependent claims.

It should also be observed that, advantageously, the proposed dispensing unit in the locked positions is tight, in such a way as to avoid the outflow of fluid from the dispensing device both when it is in the vertical or operating position and when it is overturned.

The proposed solution advantageously makes it possible to provide a fluid dispensing device or unit that is more reliable than the units of a device of known type.

Still advantageously, the proposed solution makes it possible to reduce the critical production points connected in particular with the tight areas.

Advantageously, the proposed solution features a reduced number of tight areas, thus guaranteeing the effectiveness of the locking action in the two positions indicated above.

The objects and advantages illustrated above will be highlighted in greater detail in the description of some preferred embodiments of the invention, provided as non-limiting examples with reference to the attached drawings, wherein:

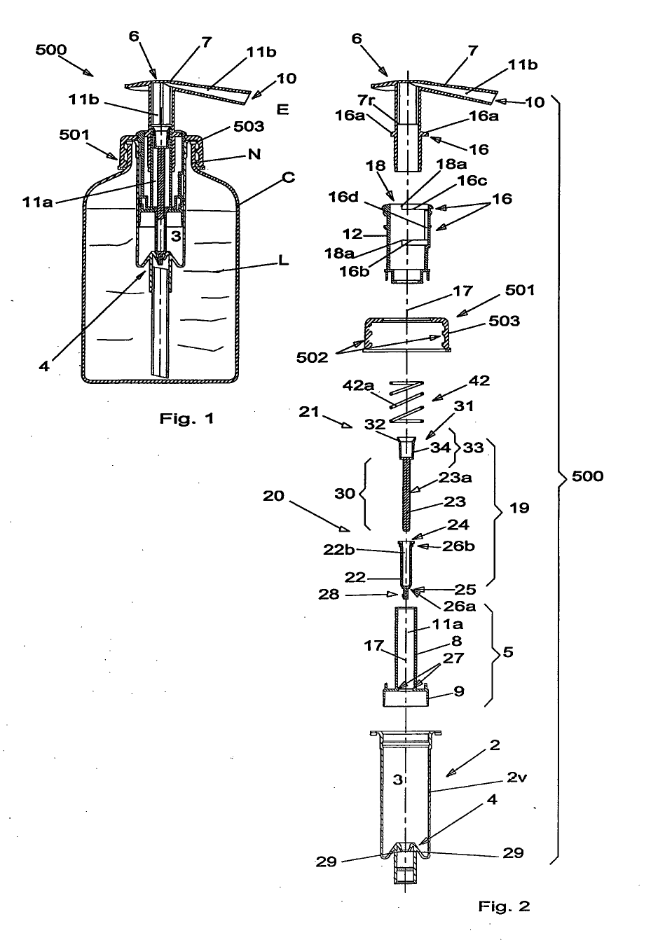

FIG. 1 shows a longitudinal cross section of an example of embodiment of a device including a unit carried out according to the invention;

FIG. 2 shows a longitudinal cross section and exploded view of the device shown in FIG. 1;

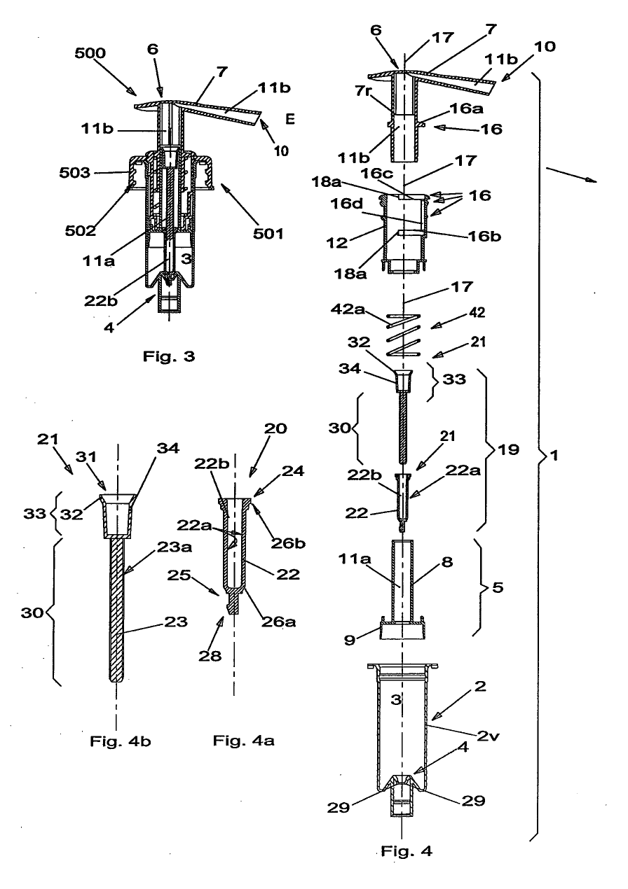

FIG. 3 shows a longitudinal cross section of the unit shown in FIG. 1;

FIG. 4 shows a longitudinal cross section and exploded view of the unit shown in FIG. 3;

FIG. 4a shows a longitudinal cross section of an element of the unit illustrated in FIG. 3;

FIG. 4b shows a longitudinal cross section of another element of the unit illustrated in FIG. 3;

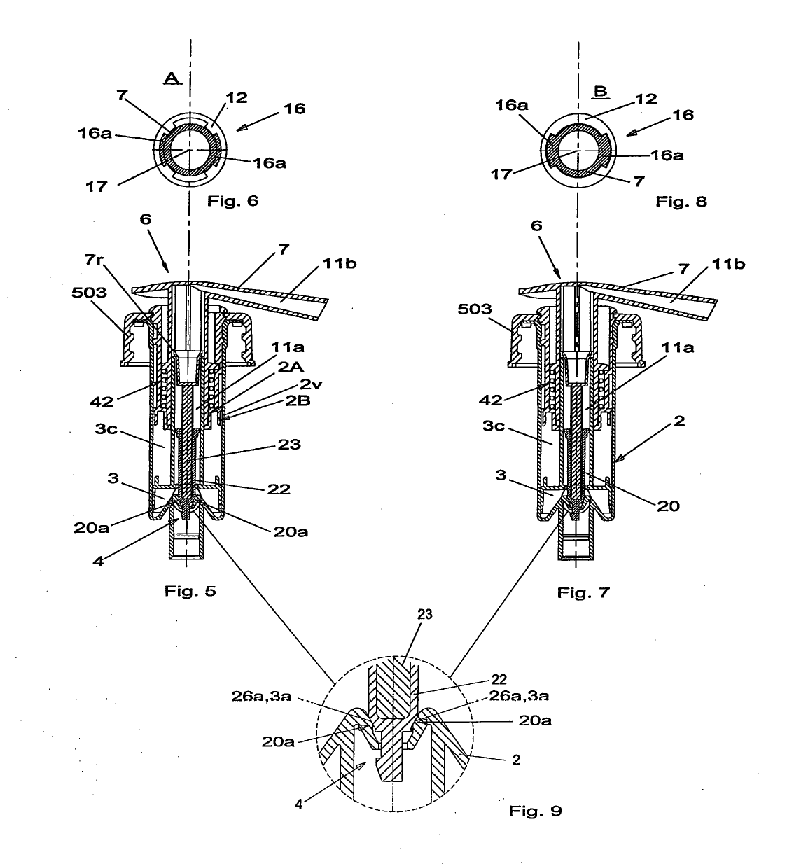

FIG. 5 shows a longitudinal cross section of the unit shown in FIG. 3 in the lower, locked position;

FIG. 6 shows a top view of some parts of the unit shown in FIG. 3, in the operating configuration shown in FIG. 5;

FIG. 7 shows a longitudinal cross section of the unit shown in FIG. 3 in the lower, unlocked position;

FIG. 8 shows a top view of some parts of the unit shown in FIG. 3, in the operating configuration shown in FIG. 7;

FIG. 9 shows an enlarged longitudinal cross section of some parts of the unit illustrated in FIGS. 5 and 7, suited to achieve tightness;

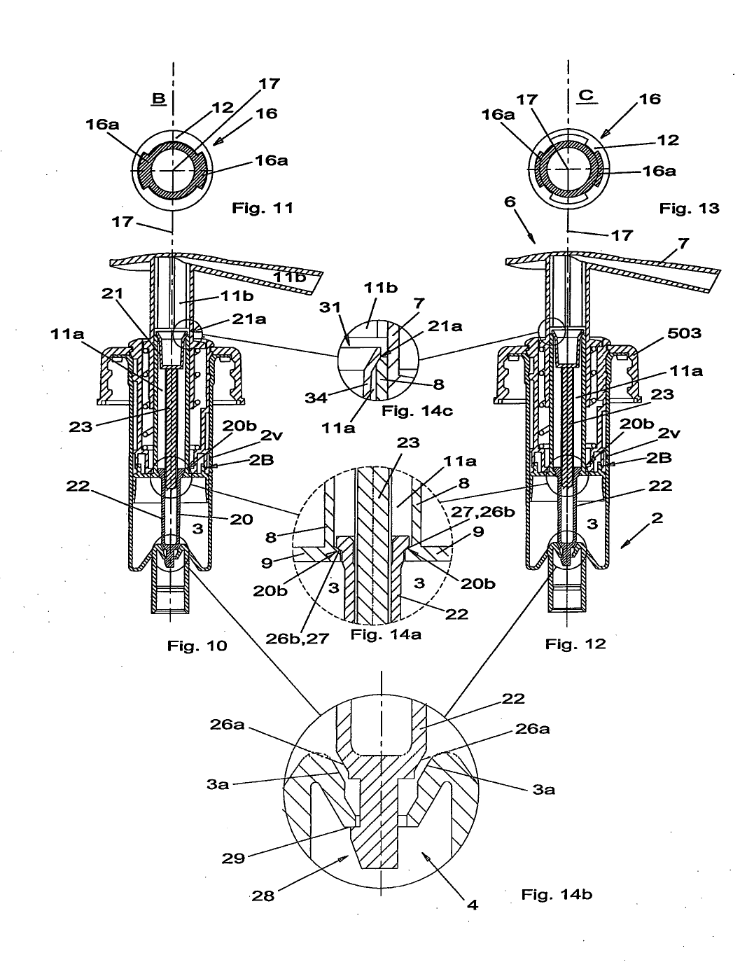

FIG. 10 shows a longitudinal cross section of the unit shown in FIG. 3 in the upper, released position;

FIG. 11 shows a top view of some parts of the unit shown in FIG. 3, in the operating configuration shown in FIG. 10;

FIG. 12 shows a longitudinal cross section of the unit shown in FIG. 3 in the upper locked position;

FIG. 13 shows a top view of some parts of the unit shown in FIG. 3, in the operating configuration shown in FIG. 12;

Figures from 14a to 14c show each an enlarged longitudinal cross section of some parts of the unit illustrated in FIGS. 10 and 12, suited to achieve tightness;

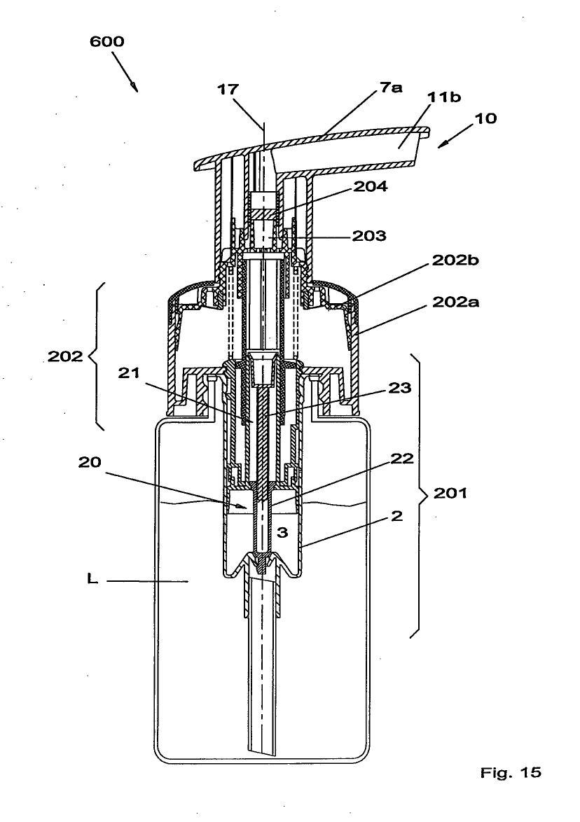

FIG. 15 shows a longitudinal cross section of another example of embodiment of a device comprising a unit according to the invention;

Figures from 16 to 19 show each a longitudinal cross section of the unit and of the device shown in FIG. 1, in the same number of operating positions;

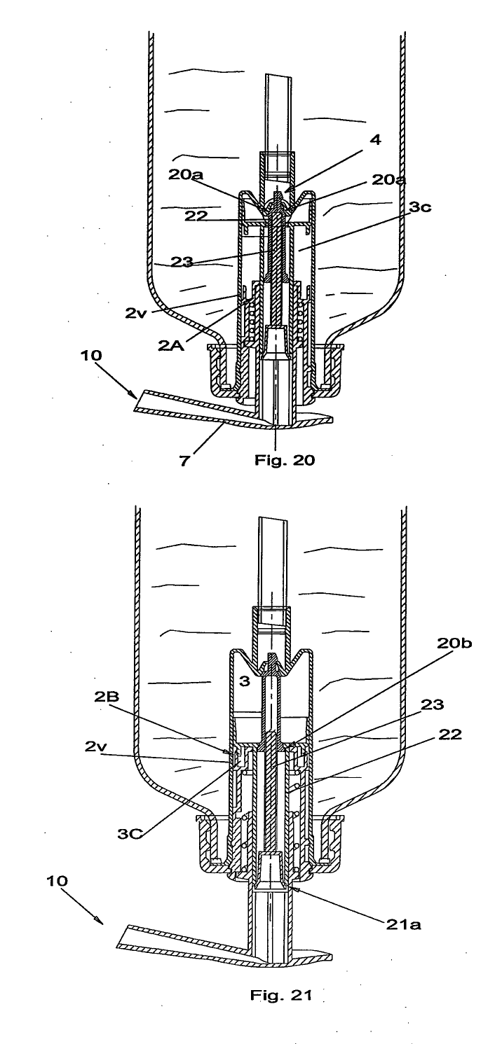

FIG. 20 shows a longitudinal cross section of the unit and of the device shown in FIG. 1, in overturned position and locked at the bottom;

FIG. 21 shows a longitudinal cross section of the unit and of the device shown in FIG. 1, in overturned position and locked at the top;

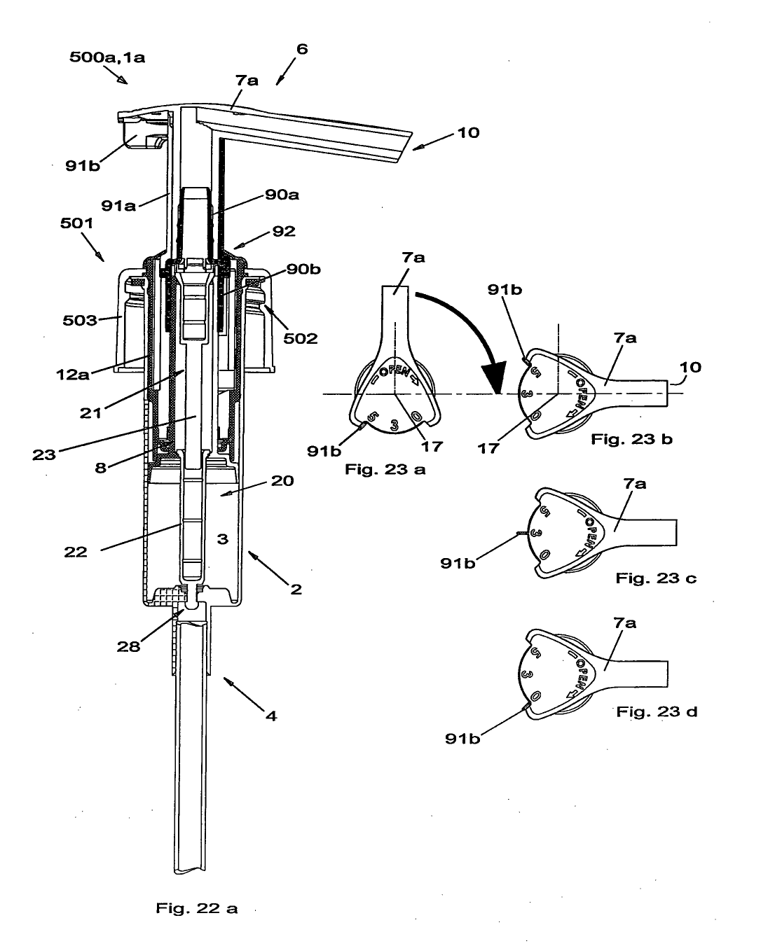

FIGS. 22a and 22b are schematic views (of a longitudinal cross section and of an exploded longitudinal cross section) of another example of embodiment of a unit and a device carried out according to the invention;

Figures from 23a to 23d are schematic views of the same number of plan views of the unit and the device of FIG. 22, in the same number of operating positions.

By way of introduction, it is important to point out that corresponding components in different examples of embodiment are indicated by the same reference numbers.

In the case of a change in the position of the parts that make up the invention, the position indications given in the individual executive examples must be transferred, according to logic, to the new position.

While the following description, made with reference to the figures, illustrates some particular embodiments of the present invention, it is clear that the invention is not limited to said particular embodiments, rather, the individual embodiments described here below clarify different aspects of the present invention, the scope and purpose of which are defined in the claims.

With reference to the attached figures, a first embodiment of a fluid dispensing unit and a device according to the invention are described here below.

The examples of embodiment of the invention described below refer to units for dispensing fluids and to the relevant device, in particular for dispensing detergent liquids. It is clear, however, that the solution proposed can be applied also to units and devices for dispensing perfumes or food products, or any other fluid in general, which must be drawn from a container and conveyed towards the outside even in the form of foam or spray.

A non-limiting embodiment of a unit for dispensing fluids together with the relevant device, subject of the present invention, to be applied to the neck N of a container C containing a fluid L to be dispensed, is shown in Figures from 1 to 4.

More precisely, the dispensing device indicated as a whole by 500 in FIGS. 1 and 2 comprises a supporting element 501 for a suction/dispensing unit 1 shown in detail in FIG. 4, provided with means 502 for fastening to the neck N of the container C.

In the case in question the supporting element 501 comprises a cap or metal ring 503 and the fastening means 502 are constituted by a thread suited to be coupled to a corresponding thread made in the neck N.

The unit 1, shown in detail in FIG. 4, is suited to draw the fluid L, in this case a detergent liquid, from the container C in order to convey it towards the outside E.

It comprises a hollow body 2 that defines a suction/compression chamber 3 for a fluid L, provided with at least one suction duct 4 for the liquid L.

The hollow body 2 is slidingly coupled with a piston 5 that can be moved from a first lower position, shown in detail in FIGS. 5 and 7, to at least one second upper position, visible in FIGS. 10 and 12.

The piston 5 comprises a rod 8 and a plunger 9.

The unit 1 and more precisely the piston 5 can be operated by the user through an actuator element 6, comprising an operating button 7, also called spout or nozzle, suited to be connected to the rod 8.

The inside of the rod 8 and the inside of the spout 7 are respectively provided with a communication duct 11a and a duct 11b for dispensing the liquid L, communicating with the suction/compression chamber 3 and, through the outlet 10, with the outside E.

The unit 1 also comprises means for locking/releasing the unit 1 itself, indicated as a whole by 16 and visible in FIGS. 2, 4, 6, 8, 11 and 13.

Said locking/releasing means 16 can be activated by the user to lock the piston 5 in the first lower position and comprise, in the case at hand, a substantially cylindrical element 12 arranged between the actuator element 6 and the hollow body 2.

The unit 1 also comprises valve means 19 suited to regulate the flow of the fluid L from the suction duct 4 to the suction/compression chamber 3 and to regulate its outflow towards the communication duct 11a in hydraulic connection with the outlet duct 11b.

Said valve means 19 comprise two elements 20 and 21 slidingly coupled with each other so that, for example, when the plunger 5 is locked in the first lower position, shown in FIG. 5, the first element 20 creates a first tight area 20a, shown in particular in FIG. 9, suited to prevent the passage of the fluid L from the suction duct 4.

More particularly, always according to the invention, in said first locked position (so-called lock down), the second element 21 interacts with the first element 20 and “locks” it in order to create the above mentioned first tight area 20a suited to intercept the suction duct 4.

It should also be noted that in the preferred non-limiting example of embodiment illustrated herein the locking/releasing means 16 can be activated by the user also to lock the piston 5 in a second upper position shown in FIG. 12.

In this position the valve means 19, and more precisely the two elements 20 and 21, are arranged so that the first element 20 creates a second tight area 20b, visible in FIGS. 10, 12 and 14a, suited to prevent the outflow of the fluid L from the suction chamber 3 to the communication duct 11a, while the second element 21 creates a third tight area 21a suited to prevent any communication between the communication duct 11a and the outlet duct 11b, shown in particular in FIG. 14c.

It should be noted that the two elements 20 and 21 interact with each other by friction on the surfaces 22a and 23a in contact with each other.

Said friction is obtained through a suitable interference between the two elements 20 and 21 and must be such that said elements 20 and 21 move together, unless one of them has one portion engaged with other parts of the unit or device. In other words, the contact surfaces of the two elements 20 and 21 generate a mutual friction that is such as to make them behave as a single body, unless the reference elements present in the pump cause their mutual movement (sliding) with respect to each other.

For example, owing to said friction, in case of overturning of the container, as shown for example in FIG. 21, the second element 21 is prevented from sliding downwards and therefore the area 21a remains tight.

In the particular non-limiting example of embodiment illustrated herein, the first element 20, shown in particular in FIG. 4a, consists of a first body 22 with substantially longitudinal development, provided with a longitudinal cavity 22b suited to receive the second element 21.

The longitudinal cavity 22b ends in a first end 24 of the body 22.

The above mentioned first element 20 is also provided with a first annular surface 26a at the other end 25.

Said first annular surface 26a is inclined with respect to the longitudinal axis of the element 20 and is suited to create the above mentioned first tight area 20a cooperating with a corresponding inclined surface 3a of the hollow body 2.

The same end 25 is also provided with a coupling element 28 suited to cooperate with the edges 29 of the suction duct 4 in order to guarantee, when the device is in the upper position, that said second tight area 20b is obtained. More particularly, it should be noted that said second tight area 20b is obtained from a second surface 26b suited to interact with a corresponding surface 27 belonging to the rod 8 that delimits the passage from the chamber 3 to the communication duct 11a.

More particularly, said surface 27 belongs to the piston 5 (to the rod 8 or the plunger 9).

As can be observed, the coupling element 28 counteracts the edges 29 under the action of the elastic means 42 when the device is in the upper position.

The second element 21, shown in particular in FIG. 4b, has a substantially longitudinal development and comprises a rod 30 suited to be slidingly coupled with the longitudinal cavity 22b. The rod 30 is provided at one end 31 with an annular sealing surface 32.

It should also be noted that the second element 21 comprises also means for collecting the liquid that hasn't been dispensed and that might accumulate in the outlet duct 11b.

Said collection means 33 comprise a collection element 34, substantially hollow and cylindrical in shape, arranged at the end 31 of the element 21 that delimits a compartment for collecting the fluid.

As far as the locking/releasing means 16 are concerned, they are suited to prevent or allow the operation of the unit 1 and can be activated by selectively turning the actuator element 6 on a longitudinal axis 17 from a first predefined locking position A, shown in FIG. 6, to a second predefined operating position B, shown in FIGS. 8 and 11, to a third locking position C, shown in FIG. 13.

The locking/releasing means 16 comprise a first opposing element consisting of at least one projecting element 16a integral with the rod of the actuator element 6 and visible in FIGS. 2 and 4. Said element 16a is suited to selectively interfere with a second opposing element and with a third opposing element belonging to the annular element 12, visible also in FIG. 6.

In the case at hand, said second opposing element (see FIGS. 2 and 4) comprises a first horizontal reference plane 16b that interferes with the element 16a, thus locking the axial movement of the plunger-rod-actuator unit in the lower position. The horizontal reference plane 16b is interrupted by a vertical groove 16d on which the projecting element 16a can slide due to the action exerted by the user to allow the movement of the plunger 9 towards its second position.

In the case at hand, the third opposing element comprises a second horizontal reference plane 16c that interferes with the element 16a, thus locking the axial movement of the plunger-rod-actuator unit when this is in the upper position. It should be noted that the horizontal reference plane 16c is connected to the first horizontal plane 16b by the vertical groove 16d.

The two extreme angular positions A and C that the actuator element 6 can assume, visible in FIGS. 5, 6 and 12, 13, are determined by stopping means 18 constituted in this case by fourth opposing elements comprising two vertical planes 18a, visible in FIGS. 2 and 4, jointed with the reference planes 16b and 16c and suited to counteract said first opposing elements 16a in order to prevent any further rotation of the actuator element 6.

The unit 1 also comprises elastic means 42 that, once the fluid has been dispensed, ensure the return of the piston 5 to the rest position and more generally its return from the lower position to the upper position.

In the case at hand, said elastic means 42 comprise a metallic helical spring 42a arranged between the actuator 6 and the plunger 9. More particularly, the spring 42a has one end that opposes the annular element 12 and the other end that opposes an annular projection present on the actuator element 6 (in the example shown herein it is constituted by the element 16a).

In other embodiments of the invention said elastic means 42 may also be constituted by equivalent elements such as, for example, an elastic bellows made of a plastic material.

It should be noted that the piston 5 and the actuator element 6 are connected with each other via connection means that, in the case at hand, comprise two annular edges not visible herein, suited to engage in corresponding annular seats created at one end of the rod 8.

In other embodiments of the invention the edges are made on the rod 8 and the annular seats on the actuator element 6.

In other embodiments mixed solutions are provided.

Another embodiment of the unit that is the subject of the invention and of the relevant device, not illustrated herein, is differentiated from the previous one due to the fact that the helical spring 42a is housed in the chamber 3 and is provided with one end that counteracts the plunger 9 and the other end that counteracts the bottom wall of the chamber 3.

A further construction variant of a device produced according to the invention, indicated as a whole by 600 in FIG. 15, is differentiated from the previous ones due to the fact that it is suited to dispense the liquid L contained in the container C in the form of foam.

In this case, the dispensing device comprises two dispensing units, indicated by 201 and 202, respectively, that can be operated in a coordinated way by the user through the actuator element 7a.

A first unit 201 is suited to draw the liquid L from the container C to convey it to a mixing chamber 203, while a second unit 202 is suited to convey, at the same time, pressurized air to the same mixing chamber 203, after which there are means suited to provide for the formation of foam.

More precisely, said means are positioned before the outlet 10 of the device and comprise a porous partition 204 suited to facilitate the formation of foam.

In the case at hand the second unit 202 comprises a hollow body 202a slidingly coupled with a plunger 202b.

A further construction variant not represented herein is differentiated from the previous one owing to the fact that also the second air suction/compression unit 202 is carried out with a collapsible chamber defined by an elastic bellows that, in this case, replaces also the helical spring.

The operation of the device subject of the invention is described with reference to the first embodiment represented in FIG. 1, since a comparison with the other devices described doesn't show any substantial differences.

From an operational point of view, the user first turns the actuator 6 in such a way as to set the device 1 to the desired operating mode.

In the configuration of the device 1 illustrated in FIG. 6, that is, lower position and actuator in position A, the locking means 16 visible in FIG. 6 are active and the first opposing elements 16a face the reference planes 16b. This prevents any axial movement of the actuator-rod-plunger unit.

In this configuration the unit 1 also includes the tight area indicated by 2A. Said tight area 2A prevents the outflow of the fluid L contained in the container C, independently of the position of the device associated with the container. More particularly, the tight area 2A prevents the outflow of the fluid L from the air vent in the container, as shown also in FIG. 20.

Vice versa, to operate the device 1 the user turns the spout or nozzle 7 on the axis 17 until it reaches the position B shown in FIG. 8. In this position the first opposing elements 16a face the groove 16d, as shown in FIG. 7, along which they can slide freely, thus allowing the piston 5 to move axially under the action of the spring 42a towards the upper position shown in particular in FIG. 10.

The device is thus ready to be used.

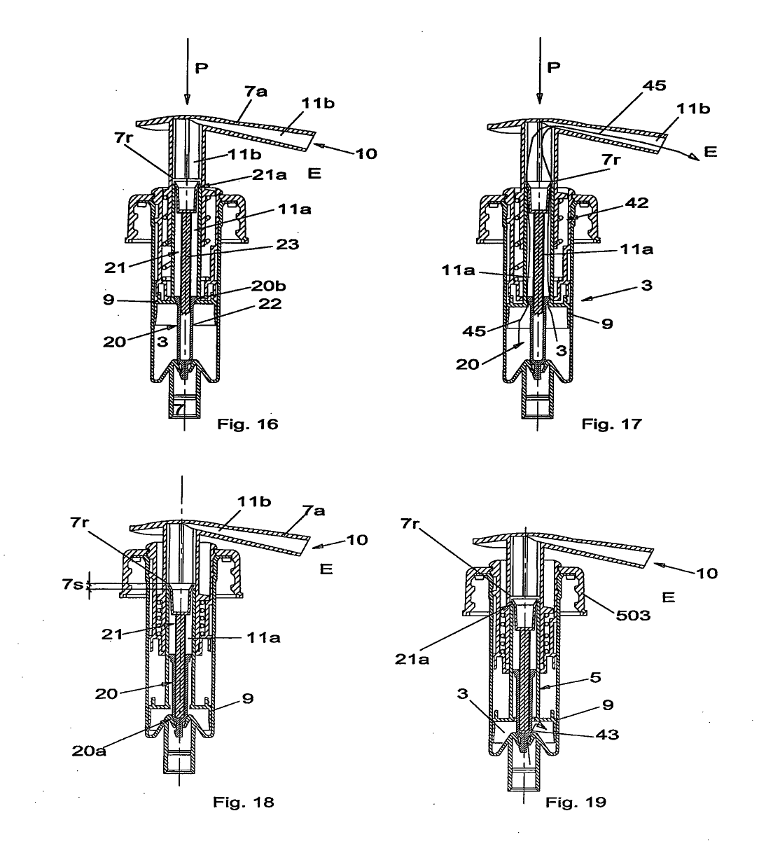

To operate the device 1, the user exerts a pressure P on the actuator 6, as shown in FIG. 16, thus moving the piston 5 axially from the upper position towards the lower position.

The movement of the piston 5 integral with the actuator 6 thus involves the two elements 20 and 21 until the first element 20 is engaged with the bottom of the chamber 3, thus defining the tight area 20a, and the second element 21 is engaged with the reference plane 7r. The further downward movement of the piston-actuator 5, 6 determines the mutual sliding movement of the two elements 20, 21.

The sliding movement of the second element 21 on the first element 20 thus ensures the flow of the liquid L contained in the suction/compression chamber 3 first towards the communication duct 11a and then towards the outlet duct 11b until it reaches the outside E, following the course indicated by 45 in FIG. 17.

In this way, furthermore, the user exerts pressure on the elastic means 42 as shown in FIG. 17 and compresses the product L contained in the suction/compression chamber 3.

It should be noted, furthermore, that at the same time the first element 20 is pushed towards the bottom of the chamber 3 thanks to the above mentioned friction force, so as to intercept the suction duct 4 and create the first tight area 20a.

The piston 5, once reached the bottom of the suction/compression chamber 3, as shown in FIG. 18, can be released by the user. This allows the elastic means 42 to move the piston 5 back to its initial rest position shown in FIG. 16.

It should be noted that the elastic return of the piston 5 involves the second element 21 in an upward movement, so that the second element 21 creates the third tight area 21a (see FIG. 19).

It should be observed in particular that said tight area is created with a certain delay with respect to the moment when the piston 5 starts its return movement. More precisely, during the return phase the movement of the plunger involves the second element 21 with a slight delay (first the plunger moves and then the element 21 is involved in the movement). The delay in the mutual movement of the two components, spout 7 and element 21, which corresponds to the allowed stroke 7s shown in FIG. 19, generates a vacuum in the duct 11b, thus making the liquid around the outlet 10 of the duct flow back into the duct itself. In other words, while the spout 7 moves upwards, the two elements 20 and 21 initially move remaining integral with each other (thanks to the friction generated between their surfaces in contact with each other), thus producing the above mentioned vacuum in the duct 11b. This takes place until the surface of the spout 7 that creates the tight area 21a comes into contact with the element 21 moving it upwards together with the element 20. This prevents undesired product leakages from the outlet 10.

It is also clear that by properly choosing said delay (determined by the distance 7s that the piston must cover before coming into contact with the element 21 to involve it in its movement) it is possible to increase or reduce such suction effect. At the same time, the first element 20 is involved by the second element 21 in an upward movement, thus opening the passage 43 between the chamber 3 and the inside of the container. The vacuum generated in the chamber 3 makes the liquid L flow into the chamber 3 itself, sucking it from the container and preparing the unit 1 and the device 500 for the successive usage, as shown in FIGS. 12, 16.

The device 500 and the unit 1 can then be locked in said upper position. More precisely, to lock the device 1 the user turns the spout or nozzle 7 on the axis 17 until it reaches position C, shown in detail in FIGS. 12 and 13. In this position the first opposing elements 16a face the reference planes 16c. This prevents any axial movement of the actuator-rod-plunger unit.

In this configuration the unit includes the tight areas indicated by 20b and 21a, which prevent the outflow of the fluid contained in the container from the duct 11b, independently of the position of the device associated with the container.

It should also be noted that the unit also includes the tight areas 2A and 2B, shown in particular in FIGS. 20 and 21.

Said tight areas 2A and 2B are suited to prevent the fluid L coming from the vent duct 2v from flowing out of the container.

More particularly, the tight area 2A (with the container in vertical position as shown in FIG. 20) prevents the passage of air from the outside towards the volume 3c, thus preventing the fluid L contained in the container from passing through the vent 2v, occupying first the volume 3c, then the space occupied by the elastic means and finally reaching the outside.

Analogously, the tight area 2B (with the container in upturned position, as shown in FIG. 21) prevents the passage of air from the outside towards the volume 3c, thus preventing the fluid L contained in the container from passing through the vent 2v, occupying first the volume 3c, then the space occupied by the elastic means and finally reaching the outside.

A further embodiment of the unit and the device carried out according to the present invention is described here below with reference to FIGS. 22a and 22b, in which components and/or characteristics that have already been described with reference to the previous figures are identified by the same reference numbers.

In particular, the dispensing unit and the device indicated as a whole and respectively by 1a and 500a in said FIGS. 22a and 22b differ from the previous embodiments owing to the fact that the unit and the relevant device can be configured so as to dispense different specific amounts of fluid L at each individual operation.

This is obtained thanks to the use of selector means suited to allow the user to select the maximum quantity of fluid L to be dispensed on each single operation, said selector means being suited to be rotated in relation to the longitudinal axis 17 of said unit 1a.

Said selector means comprise a selector element 91 that is rotatably coupled with a cylindrical portion 70a extending towards the lower part of the spout 7a. Said element 91 is arranged between the annular element 12a and the actuator element 6.

More precisely, said selector element 91 comprises a substantially cylindrical body 91a provided at one end with a maneuvering portion 91b and at the other end with part of the locking/releasing means 16 of the unit 1a that in the example consist of at least one projecting element 91c (in the example illustrated herein they are two). Said projecting element 91c is suited to be slidingly coupled not only with the vertical groove 16d but also with the additional vertical grooves indicated by numbers 120a and 120b made in the annular element 12a to allow the movement of the piston 5, as explained above. As can be observed, in particular in FIG. 22b, each groove 16d, 120a and 120b ends with a horizontal reference plane respectively indicated by numbers 16b′, 120a′ and 120b′. The three above mentioned grooves 16d, 120a and 120b also have different lengths (extension along the longitudinal axis 17). They thus define the same number of different lengths of the maximum stroke allowed for the piston 5, corresponding to a maximum quantity of fluid to be dispensed. The position of the projecting element 91c with respect to the annular element 12a can be varied by the user by means of the maneuvering portion 91b, as schematically shown in Figures from 23a to 23d.

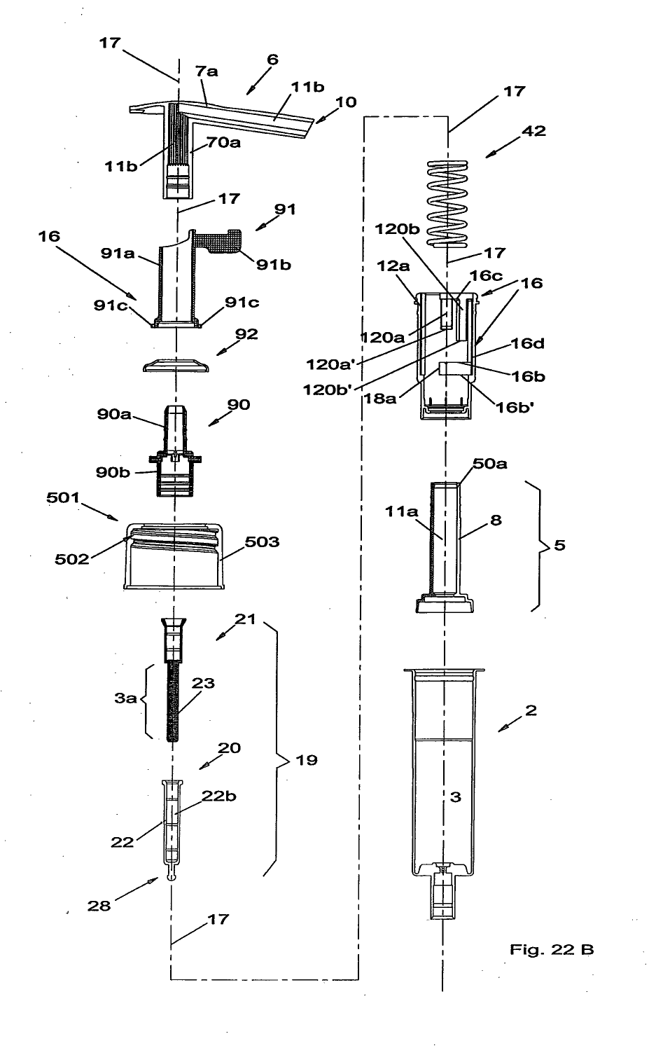

Thus, in this case, the user, before operating the device 500a must move the unit 1a from the locked position shown in FIG. 23a to the released position, by rotating the spout 6 as described above.

The user can then move the maneuvering portion 91b, arranging it in one of the positions indicated in Figures from 23b to 23d to obtain the selective coupling of the projecting element 91c with a corresponding groove 16d, 120a and 120b and thus a corresponding maximum quantity of dispensed fluid through the operation of the piston 5.

Advantageously, the selector element 91 makes it possible to select the maximum quantity of liquid to be dispensed without changing the orientation of the spout 7a (actuator element 6). Still advantageously, it should be noted that owing to the particular shape of the actuator element 91 the maneuvering portion 91b is substantially positioned on the same plane defined by the upper surface of the actuator element 6. This allows the user to benefit from an easier visual access to the maneuvering portion 91b and thus to be able to select simply and rapidly the maximum quantity of fluid that he/she intends to dispense. It is also possible to use the upper surface of the actuator element in order to create references that usefully allow the operator to understand what is the maximum quantity of fluid to dispense.

In the example shown in FIG. 23a it is possible to observe that the numbers 0, 3, 5 have been indicated on said surface, in order to identify the maximum quantities that can be dispensed if the element 91b is brought to one of said admissible positions.

Still advantageously, it should be noted that the proposed solution makes it possible to separate/add the locking/releasing function of the unit 1a and of the relevant device 500a from/to the function for the selection of the maximum quantity of fluid to be dispensed, as well as to provide for the maneuvering means 91b to be arranged in a more ergonomic position that can be easily reached by the user.

It should also be noted that according to the embodiment shown in FIGS. 22a and 22b the actuator element 6a is connected to the piston 5 through a connection element indicated as a whole by 90.

Said connection element comprises a first portion 90a suited to be coupled with the end 70a of the actuator element 6a and a second portion 90b suited to be coupled with the end 50a of the piston 5.

Said connection element 90 is suited to allow the hydraulic communication between the communication duct 11a and the outlet duct 11b.

The introduction of said connection element 90 advantageously makes it possible to assemble the unit 1a and the corresponding device 500a in a quicker and more functional way. Said assembly operation substantially consists in the coupling of the various elements described as shown in FIG. 22b. Advantageously, it should finally be noted that the embodiment 500a uses a sealing element indicated as a whole by 92, suited to achieve tightness between the selector element 91 and the annular element 12a in order to prevent any fluid from flowing into/out of the unit 1a, while at the same time guaranteeing the necessary freedom of movement of the selector element 91. The operation of the unit 1a and of the corresponding device 500a, in particular in relation to the sealing elements (positions assumed by the latter) during the operating steps, is substantially as described above concerning the other embodiments, to which therefore reference should be made. Analogously, the unit 1a and the relevant device 500a can have any of the configurations indicated by the letters A, B and C in the description of the embodiment of FIG. 1, besides the additional configurations that can be chosen to dispense different quantities of fluid L.

It is clear that the solutions described above and in particular the presence of the selector element 91 cooperating with the corresponding grooves 16d, 120a, 120b, the connection element 90 and the sealing element 92 can be present in all the embodiments described above.

It is also clear that in some solutions the grooves can be replaced by projections and in this case the corresponding projections will be replaced by grooves.

Advantageously and preferably, the unit 1 and the relevant device proposed can be carried out—in all their parts—also in a plastic or synthetic material. This makes it possible to obtain a unit and a device that can be completely recycled, with no need to previously separate parts in metallic materials or, in any way, incompatible materials.

It should be noted that the tight areas created in the units and in the corresponding devices in the first and second locked positions are obtained also when the unit and the device are in said first lower position and in said second upper position (therefore, even if the device isn't locked), in all the embodiments described.

Obviously, various modifications can be made to the fluid dispensing unit and device that are the subjects of the present invention, without departing from the scope or object of the invention. It should therefore be noted that the scope of the present invention is defined by the claims, including all fours equivalent to those claimed.

The above description clearly shows that the solution proposed allows the drawbacks described to be eliminated and the set goals to be achieved.

In particular, the proposed solution makes it possible to reduce the critical production points connected in particular with the tight areas.

Advantageously, the proposed solution makes it also possible to reduce the number of tight areas, thus guaranteeing the functionality of the locking action in the two positions.

Again advantageously, the proposed solution also makes it possible to reduce production costs.

Again advantageously, the proposed solution also prevents the fluid from flowing out of the container when the device is in the locked position.

It should also be observed that the proposed solution advantageously makes it possible to produce devices for dispensing fluids that can be assembled automatically.

Even though the invention has been described making reference to the attached drawings, upon implementation changes can be made that shall all be considered protected by the present patent, provided that they are within the scope of the inventive concept expressed in the following claims.

It is also worth noting that where the characteristics mentioned in the following claims are followed by reference signs, these are used merely to improve the comprehensibility of the claim itself and shall not be seen as limiting its interpretation in any way.

Without departing from the scope of the invention, the person skilled in the art can change and improve the dispensing device or the unit subject of the invention as suggested by the natural evolution of the art.

It should also be underlined that all the parts can be replaced with other technically equivalent parts, that any material can be used, provided that it is compatible with the intended use, and that the various elements can have any size, depending on the needs.

1.-28. (canceled)

29. Unit (1, 1a) for dispensing fluids (L) suited to be applied to a container, said unit comprising:
at least one hollow body (2) defining one suction/compression chamber (3) for a fluid (L) and provided with at least one suction duct (4) for the fluid (L), to which a piston (5) is slidingly coupled, wherein said piston (5) is movable from a first lower position to at least one second upper position;
valve means (19) suited to regulate the flow of the fluid (L) from said at least one suction duct (4) into said suction/compression chamber (3) and to regulate its outflow towards a communication duct (11a) in hydraulic connection with an outlet duct (11b) of said device;
locking means (16) that can be activated by the user to lock said piston (5) alternatively in said lower and upper positions;
said valve means (19) comprising two elements (20, 21) slidingly coupled with each other so that, when said piston (5) is locked in said first lower position, said first element (20) creates a first tight area (20a) suited to prevent the passage of the fluid (L) from said suction duct (4);
characterized in that when said piston (5) is locked in said second position, said elements (20, 21) are arranged in such a way that said first element (20) creates a second tight area (20b) suited to prevent the outflow of said fluid (L) from said suction chamber (3) to said communication duct (11a), and said second element (21) creates a third tight area (21a) suited to prevent communication between said communication duct (11a) and said outlet duct (11b).

30. Unit according to claim 29, characterized in that in said first locking position said second element (21) interacts with the first element (20) and locks it in such a way as to create said first tight area (20a).

31. Unit according to claims 29, characterized in that when said piston is moved from said second upper position to said first lower position in order to dispense said fluid (L), said first element (20) closes said suction duct.

32. Unit according to claim 29, characterized in that said locking/releasing means (16) can be activated by the user also to lock said plunger (5) in said second upper position.

33. Unit according to claim 29, characterized in that said two elements (20, 21) interact with each other through friction on the surfaces in contact with each other (22a, 23a).

34. Unit according to claim 29, characterized in that said first element (20) comprises a first body (22) with substantially longitudinal development having a longitudinal cavity (22b) suited to receive said second element (21), said longitudinal cavity ending in a first end (24).

35. Unit according to claim 29, characterized in that said first element (20) also comprises at one end (25) a first annular surface (26a), inclined in relation to the longitudinal axis of said first element (20) and suited to create said first tight area (20a).

36. Unit according to claim 35, characterized in that said end (25) is also provided with a coupling element (28) suited to cooperate with the edges (29) of said suction duct (4), in order to guarantee that said second tight area (20b) is created when said device is in said upper position.

37. Unit according to claim 36, characterized in that said coupling element (28) counteracts said edges (29) under the action of elastic means when the device is in said upper position.

38. Unit according to claim 29, characterized in that said second tight area (20b) is obtained from a second surface (26b) suited to interact with a corresponding surface (27) belonging to said piston.

39. Unit according to claim 29, characterized in that said second element (21) has a substantially longitudinal development and comprises a rod (30) suited to slidingly couple with said first element.

40. Unit according to claim 39, characterized in that said rod (30) is provided at one end (31) with an annular sealing surface (32).

41. Unit according to claim 29, characterized in that said second element (21) also comprises means for collecting the fluid that is not dispensed.

42. Unit according to claim 40, characterized in that said collection means (33) comprise a hollow collection element (34) arranged at one end of said element (21).

43. Unit (1) according to claim 29, characterized in that said locking/releasing means (16) comprise a first opposing element suited to selectively interfere with a second counteracting element and with a third counteracting element belonging to an annular element (12) integral with said hollow body.

44. Unit (1) according to claim 29, characterized in that said unit (1) also comprises elastic means (42) suited to ensure, once the fluid has been dispensed, the return of said piston (5) from said first position to said second position.

45. Unit (1) according to claim 29, characterized in that said at least one actuator element comprises a spout or nozzle (7a) removably connected to said rod (8).

46. Unit according to claim 29, characterized in that when said plunger is moved from said first lower position to said second upper position at least one of said elements (20, 21) is set moving by said piston (5) with such a delay to create a vacuum inside said dispensing duct (11b) in order to suck the fluid that may be present in the outlet (10) towards said dispensing duct (11b).

47. Device (500, 500a) for dispensing fluids, comprising a support element (501) for a unit for dispensing a fluid (L), provided with means (502) for connection to the neck (N) of a container (C) containing said fluid (L), characterized in that said at least one unit (1, 1a) for dispensing fluids is carried out according to claim 29.

48. Device (600) for dispensing fluids in the form of foam, comprising:
a support element (501) for a first unit (201) for dispensing fluids and/or for a second unit for dispensing pressurized air (202), said support element being provided with means for fastening to the neck (N) of a container (C) containing said fluid (L);
at least one mixing chamber (203) for the air and fluid dispensed by said units (201, 202);
means suited to facilitate the production of said foam positioned upstream of the outlet of said device (600);
characterized in that at least one of said units (201, 202) for dispensing fluids is carried out according to claim 29.

49. Device according to claim 47, characterized in that it also comprises a sealing element (92) arranged between said support element (501) and said unit (1, 1a), said sealing element (92) being suited to achieve water tightness and prevent any fluid from getting into said units (1, 1a) from the outside.

50. System for dispensing a fluid or a mixture, comprising a container for said fluid or mixture and a device for dispensing said fluid or mixture (500, 600), characterized in that said device is carried out according to claim 47.
